(19) United States
(12) Patent Application Publication
(10) Pub. No.: US 2014/0201098 A1
(43) Pub. Date: Jul. 17, 2014

(54) SYSTEM FOR CANDIDATE AUTHENTICATION AND METHODS THEREOF

(71) Applicants: VISHAL SINGHAL, COCHIN (IN); PREETI SINGHAL, COCHIN (IN)

(72) Inventors: VISHAL SINGHAL, COCHIN (IN); PREETI SINGHAL, COCHIN (IN)

(21) Appl. No.: 14/016,255

(22) Filed: Sep. 3, 2013

(30) Foreign Application Priority Data
Jan. 17, 2013 (IN) 235/CHE/2013

(51) Int. Cl. G06Q 10/10

(52) U.S. Cl. CPC G06Q 10/1053
USPC 705/321

(57) ABSTRACT

Systems and methods for candidate authentication, wherein the system comprises,
a. at least one input interface;
b. at least one storage interface;
c. at least one request generation interface;
d. at least one request communicating interface;
e. at least one authenticating interface;
f. at least one response processing interface; and
g. at least one display interface.

### FIELD OF THE INVENTION

The present invention relates to the field of candidate authentication and more particularly to systems and methods allowing a third party authenticator to authenticate a candidate or candidate attributes.

### BACKGROUND OF THE INVENTION

In this age of Information Technology, our lives are dependent on the information provided and obtained mostly in or from the network based/online/internet medium. However, vast information/data pool also attracts vast scope of inaccuracies. Inaccuracy of information may lead to various problems and/or communication gaps. Hence, accuracy of the information/data obtained or provided is required to be authenticated before being processed or utilized for any required purpose. Any information provided in respect of documents submitted, resume, curriculum vitae or bio-data uploaded should be verified. Information provided by a person or candidate, seeking a job in an organization, or seeking admission in an educational institution, or a tenant seeking a property, or a land-owner searching a client, or person seeking bank services, or person buying new mobile connections or telephone connections, or for matrimonial purpose, etc. is typically required to be verified.

It is known that getting the right candidate is essential for organizations or institutions when the time and expense associated with choosing, admitting, recruiting; and training candidates are considered. Thus, verifying background details like educational and professional details of the candidate has become extremely important. Unverified candidates may lead to unsuccessful hires or admissions, which may eventually lead to low productivity, fraud and dishonesty by candidates, disruptive or poorly performing staff members.

Statistics and research show that during the past 10 years, the topic of resume fraud has retained the attention of print-media and web-based media worldwide especially in United States, India and Pakistan. Newspaper articles, books, and bloggers have insisted that employers in the United States are confronting an “epidemic” of employment resumes laden with bogus qualifications. Over 53% of job seekers lie on their resumes. According to the independent surveys carried out in United States and India in 2011-2012 over 70% of college graduates admit to lying on their resumes to get hired, 80% of all resumes are misleading, 20% state fraudulent degrees, 30% show altered employment dates, 40% have inflated salary claims, 30% have inaccurate job descriptions and 27% give falsified references. Applicants providing incorrect tenures of past employment remain the single largest reason for employment-related discrepancies in India. In the second quarter, travel and hospitality, education, healthcare and pharmacy sector companies had the highest number of employment-related discrepancies. Middle-management-level applicants accounted for 21% of discrepancies in the second quarter compared with 19% in the first quarter.

(Sources:
1. http://info.shine.com/Career-Advice-Articles/Career-Advice/Resume-details-truth-or-white-collar-lies/5406/cid2.aspx
2. http://businesscommunication.org/wp-content/uploads/2011/04/13ABC2008.pdf
3. http://fakeresume.com/)

As seen in the art, employers or universities carry out their own internal checks to verify employee credentials, asking the previous employer about the status and accuracy of information provided by the candidate. Similar checks are carried out to verify the educational details of the candidate. Few employers or educational institutes hire a third party to verify candidate credentials. Hiring third party or even internal check for professional and education verification process can be incomplete, non-reliable, expensive and slow. Some schools, institution or organizations have policies prohibiting anyone other than the former student or employee from accessing records. Name variations, incorrect or missing student or employee numbers, etc., can occasionally cause educational details or employee records to be overlooked. Moreover information like, bonus, incentives, reasons for internal appraisal, IJPs (internal job postings), exact salary split up, GPA (grade point average), subject wise score, honours' information, etc. is not commonly provided by professional organization or educational institutions. Thus, the verification or authentication processes found in art may be time consuming, expensive, incomplete, or ineffective which do not provide a full picture of the authenticity of the candidate.

The present invention in its various embodiments addresses the above and other possible drawbacks and limitations of the currently used systems and methods relating to the field of systems and methods for candidate authentication, more particularly to systems and methods allowing a third party authenticator to authenticate a candidate or candidate attributes.

### SUMMARY OF THE INVENTION

The present invention in a broad aspect provides systems and methods for candidate authentication, wherein the system comprises,

at least one input interface;
at least one storage interface;
at least one request generation interface;
at least one request communicating interface;
at least one authenticating interface;
at least one response processing interface; and
at least one display interface;
wherein said at least one input interface is capable of allowing a candidate to enter at least one attribute linked to a candidate profile; and
wherein said at least one storage interface is capable of storing said at least one attribute entered by said candidate; and
wherein said at least one request generation interface is capable of generating a request for authentication of said at least one attribute stored in said at least one storage interface, to be communicated to an authenticator; and
wherein said at least one request communicating interface is capable of communicating said request for authentication from said at least one request generation interface to said at least one authentication interface; and
wherein said at least one authentication interface is capable of allowing said authenticator to submit a response to said request for authentication; and wherein said at least one response processing interface is capable of setting an authentication indicator corresponding to said response; and
wherein said at least one display interface is capable of displaying said at least one attribute along with said authentication indicator capable of being viewed by a viewer.

### BRIEF DESCRIPTION OF THE DRAWINGS

FIG. 1 provides a flowchart of an embodiment of the invention illustrating the method of candidate authentication in accordance with the present invention.

FIG. 2 provides a flowchart of an embodiment of the invention illustrating an example of the working of the present invention.

FIG. 3 illustrates an example of a user system interaction for the purpose of the present invention.

FIG. 4 illustrates an example of the display interface as would be visible to a candidate who has logged in for the first time into the system.

FIG. 5 illustrates an example of the display interface as would be visible to a viewer logged in into the system to view the authentication details of a candidate

### DETAILED DESCRIPTION OF THE INVENTION

The present invention in an embodiment provides a system for candidate authentication, wherein the system comprises,

at least one input interface;
at least one storage interface;
at least one request generation interface;
at least one request communicating interface;
at least one authenticating interface;
at least one response processing interface; and
at least one display interface;
wherein said at least one input interface is capable of allowing a candidate to enter at least one attribute linked to a candidate profile; and
wherein said at least one storage interface is capable of storing said at least one attribute entered by said candidate; and
wherein said at least one request generation interface is capable of generating a request for authentication of said at least one attribute stored in said at least one storage interface, to be communicated to an authenticator; and
wherein said at least one request communicating interface is capable of communicating said request for authentication from said at least one request generation interface to said at least one authentication interface; and
wherein said at least one authentication interface is capable of allowing said authenticator to submit a response to said request for authentication; and
wherein said at least one response processing interface is capable of setting an authentication indicator corresponding to said response; and
wherein said at least one display interface is capable of displaying said at least one attribute along with said authentication indicator capable of being viewed by a viewer.

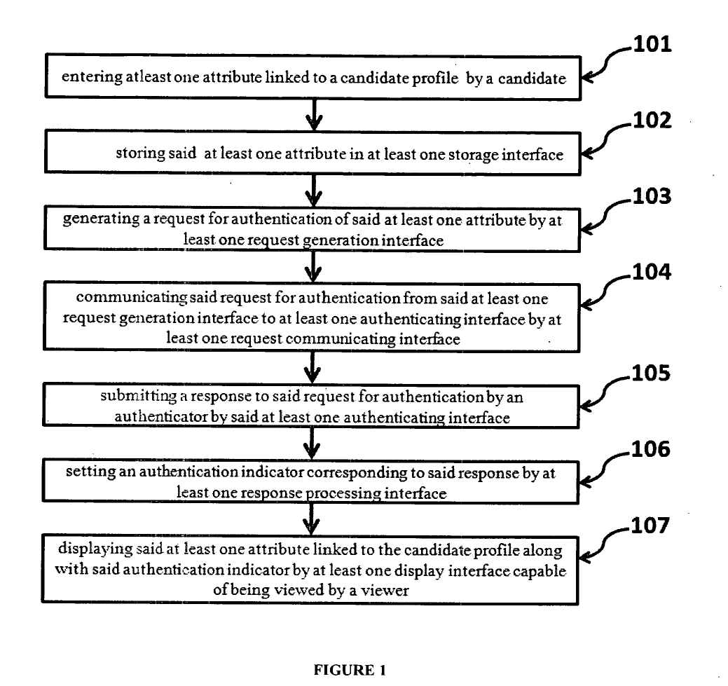

In another embodiment of the invention a method is provided for candidate authentication, wherein the method comprises steps of
a) entering at least one attribute linked to a candidate profile through at least one input interface by a candidate (As shown in Step 101 of FIG. 1);
b) storing said at least one attribute in at least one storage interface (As shown in Step 102 of FIG. 1);
c) generating a request for authentication of said at least one attribute by at least one request generation interface (As shown in Step 103 of FIG. 1);
d) communicating said request for authentication from said at least one request generation interface to at least one authenticating interface by at least one request communicating interface (As shown in Step 104 of FIG. 1);
e) submitting a response to said request for authentication by an authenticator by said at least one authenticating interface (As shown in Step 105 of FIG. 1);
f) setting an authentication indicator corresponding to said response by at least one response processing interface (As shown in Step 106 of FIG. 1); and
g) displaying said at least one attribute linked to the candidate profile along with said authentication indicator by at least one display interface capable of being viewed by a viewer (As shown in Step 107 of FIG. 1).

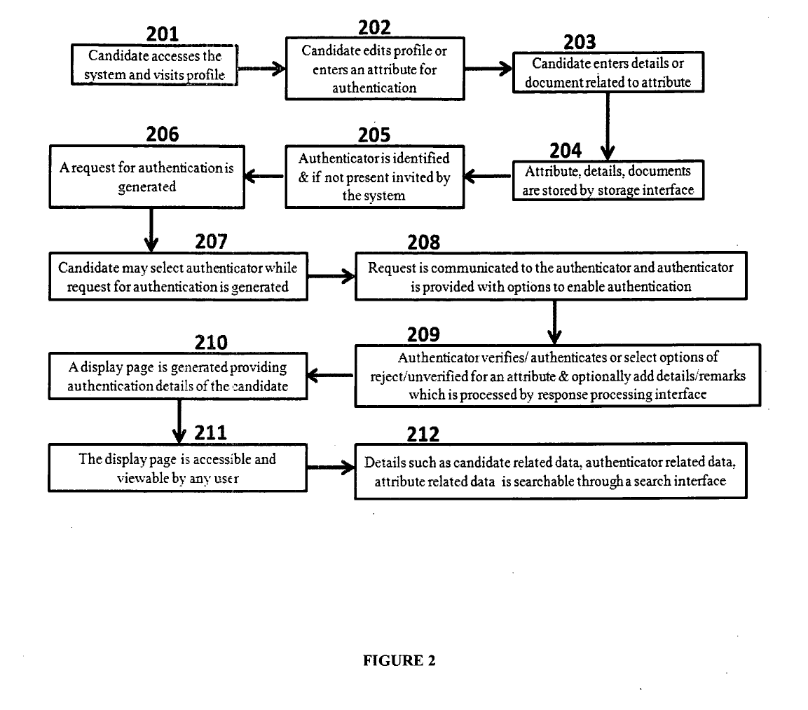

In yet another embodiment of the invention, an example of the working of the present invention may employ the following steps:
a) Candidate accesses the system and visits profile (As shown in Step 201 of FIG. 2);
b) Candidate edits profile or enters an attribute for authentication (As shown in Step 202 of FIG. 2);
c) Candidate enters details or document related to attribute (As shown in Step 203 of FIG. 2);
d) Attribute, details, documents are stored by storage interface (As shown in Step 204 of FIG. 2);
e) Authenticator is identified & if not present invited by the system (As shown in Step 205 of FIG. 2);
f) A request for authentication is generated (As shown in Step 206 of FIG. 2);
g) Candidate may select authenticator while request for authentication is generated (As shown in Step 207 of FIG. 2);
h) Request is communicated to the authenticator and authenticator is provided with options to enable authentication (As shown in Step 208 of FIG. 2);
i) Authenticator verifies/authenticates or select options of reject/unverified for an attribute & optionally add details/remarks which is processed by response processing interface (As shown in Step 209 of FIG. 2);
j) A display page is generated providing authentication details of the candidate (As shown in Step 210 of FIG. 2);
k) The display page is accessible and viewable by any user (As shown in Step 211 of FIG. 2); and
l) Details such as candidate related data, authenticator related data, attribute related data is searchable through a search interface (As shown in Step 212 of FIG. 2).

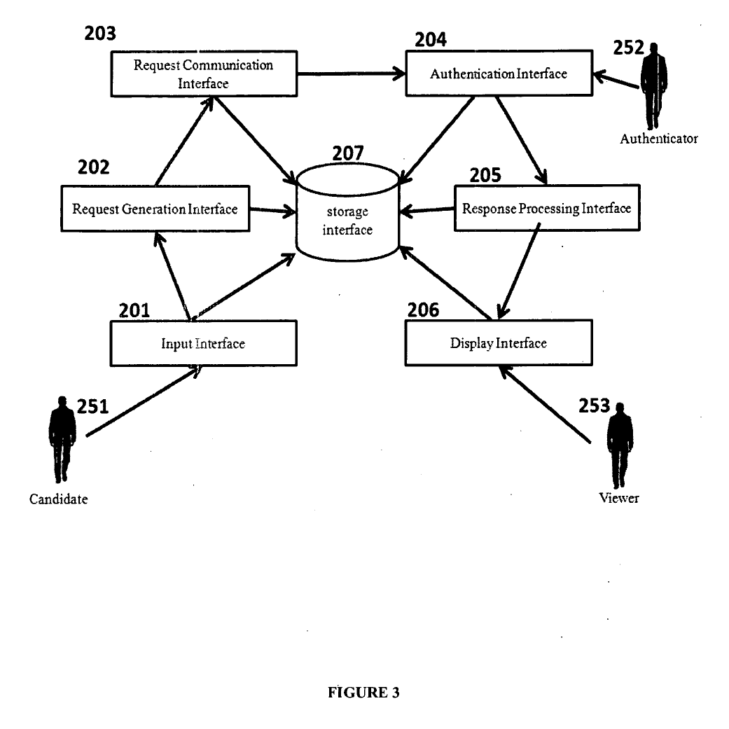

FIG. 3 illustrates an example of a user system interaction for the purpose of the present invention. A candidate 251 accessed and interacts with the Input Interface 201 which is linked to a Request Generation Interface 202 which is further linked to a Request Communication Interface 203 which communicates the generated request to an Authentication Interface 204 which is accessed by an authenticator 252 who provides an authentication response by authenticating or rejecting the attribute details associated with the request, and the authentication response provided by the authenticator 252 is processed by a Response Processing Interface 205 which is further linked to Display Interface 206 whereby the Display Interface 206 is viewable and accessible by a viewer or any user of the system. The components of the system Input Interface 201, Request Generation Interface 202, Request Communication Interface 203, Authentication Interface 204, Response Processing Interface 205, Display Interface 206 are all capable of being linked to one or more storage devices or at least one Storage Interface 207.

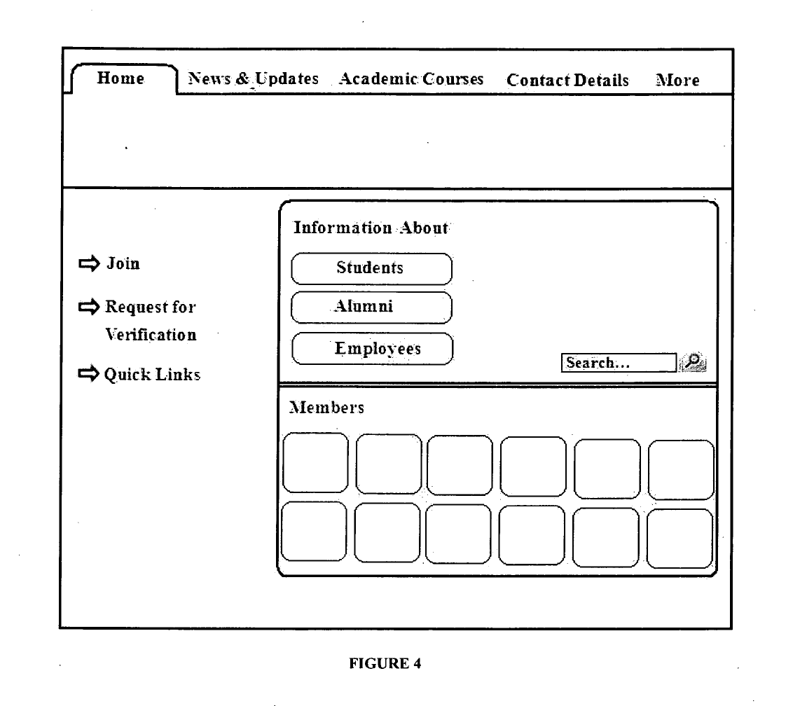

FIG. 4 illustrates an example of the display interface as would be visible to a candidate who has logged in for the first time into the system. The candidate is allowed to access or input details related to multiple aspects examples of which may be News & Updates, Academic Courses, Contact Details, Request for verification, Other Students, Alumni, Employees, Other members of the system. On accessing request for verification, a candidate may be able to access another page of the system which allows it to carry out the method steps involved in the present invention.

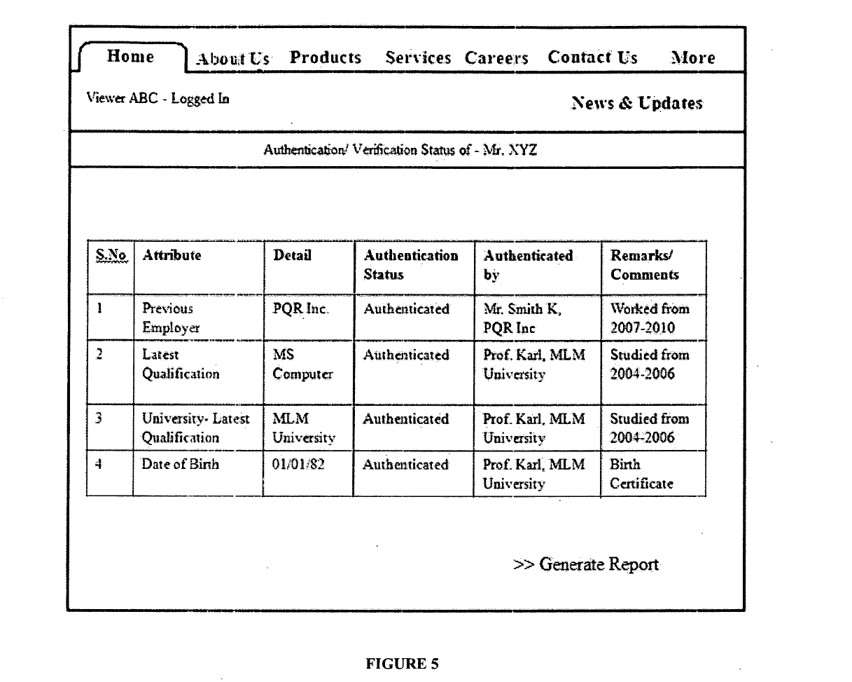

FIG. 5 illustrates an example of the display interface as would be visible to a viewer logged in into the system to view the authentication details of a candidate. A tabular representation of authentication details may be obtained showing the authentication status, name of the authenticator and associated remarks to the authentication status for a particular candidate. A report generation interface can be accessed to provide a report of the display interface contents or associated data to a user in a suitable format.

In an embodiment of the invention, an authenticator creates a candidate profile of a candidate and invites the candidate to join the system via the communication interface, wherein on acceptance of the invitation by the candidate, the authenticator enters at least one attribute linked to said candidate profile through said input interface.

In an embodiment of the invention, a candidate creates a candidate profile and invites said authenticator to join the system via said communication interface.

In an embodiment of the invention, the system further comprises of a notification interface.

In an embodiment of the invention, the notification interface is capable of sending a notification to any user of the system.

In another embodiment of the invention, a viewer may request a candidate to enter specific attributes through an input interface.

In an embodiment of the invention, the system further comprises of a report generation interface.

In an embodiment of the invention, an authentication interface may provide a hyperlink sent to an authenticator through any communication medium.

In an embodiment of the invention, an input interface may provide a hyperlink to a candidate.

In an embodiment of the invention; a display interface may provide a hyperlink to a viewer.

In an embodiment of the invention, the systems and methods of the present invention may be used in relation to a Dating service.

In an embodiment of the invention, the systems and methods of the present invention may be used in relation to a Matrimonial service.

In an embodiment of the invention, the systems and methods of the present invention may be used in relation to a bank or financial institution.

In an embodiment of the invention, the systems and methods of the present invention may be used in relation to identity verification mechanisms by government authorities.

In an embodiment of the invention, the systems and methods of the present invention may be used in relation to an Employment or job portal capable of allowing a job seeker to access information of a role offered by an employer and capable of allowing an employer to access information of a job seeker for a role and capable of allowing communication between a job seeker and an employer either directly or indirectly.

In an embodiment of the invention, the systems and methods of the present invention may be used in relation to the intake of an academic institution.

In an embodiment of the invention, the systems and methods of the present invention may be used in relation to a government service.

In an embodiment of the invention, the systems and methods of the present invention may be used in relation to a non-government service.

In an embodiment of the invention, one or more attributes may be predefined in the system.

In an embodiment of the invention, an attribute linked to a candidate profile may be any attribute such as but not limited to date of joining, tenure, role during employment, job functions performed during the tenure, awards/recognition of any kind during the period, salary that was awarded to the employee during that period, additional data that is of high relevance during the period of employment, feedbacks/appraisal cycles, outcomes, offer letter, termination letter, educational details, date of joining, date of passing, class obtained, extracurricular achievements, name of the institution, name of the previous employer, criminal record, character verification, health record, credit rating, family background, financial details, address, languages know, computer knowledge, date of birth, nationality, marital status, physical attributes, and combinations thereof.

The present invention in another embodiment provides a system for candidate authentication, wherein the system comprises,
a) at least an electronic device;
b) at least a data storage device; and
c) at least a data processing unit;
   wherein said at least an electronic device comprises,
   at least one input interface; and
   at least one display interface;
   and wherein said at least a data storage device comprises,
   at least one storage interface;
   and wherein said at least a data processing unit comprises,
   at least one request generation interface;
   at least one request communicating interface;
   at least one authenticating interface; and
   at least one response processing interface;
   wherein said at least one input interface is capable of allowing a candidate to enter at least one attribute linked to a candidate profile; and
   wherein said at least one storage interface is capable of storing said at least one attribute entered by said candidate; and
   wherein said at least one request generation interface is capable of generating a request for authentication of said at least one attribute stored in said at least one storage interface, to be communicated to an authenticator; and
   wherein said at least one request communicating interface is capable of communicating said request for authentication from said at least one request generation interface to said at least one authentication interface; and
   wherein said at least one authentication interface is capable allowing said authenticator to submit a response to said request for authentication; and
   wherein said at least one response processing interface is capable of setting an authentication indicator corresponding to said response; and
   wherein said at least one display interface is capable of displaying said at least one attribute along with said authentication indicator capable of being viewed by a viewer.

The present invention in another embodiment provides a computer program product for candidate authentication, the computer program product embodied in a computer readable medium that, when executing on a computer, performs steps comprising entering at least one attribute linked to a candidate profile through at least one input interface by a candidate;

storing said at least one attribute in at least one storage interface;
generating a request for authentication of said at least one attribute by at least one request generation interface;
communicating said request for authentication from said at least one request generation interface to at least one authenticating interface by at least one request communicating interface;
submitting a response to said request for authentication by an authenticator by said at least one authenticating interface;
setting an authentication indicator corresponding to said response by at least one response processing interface; and
displaying said at least one attribute linked to the candidate profile along with said authentication indicator by at least one display interface capable of being viewed by a viewer.

In an embodiment of the invention, the authentication indicator shall provide the status of authentication.

In an embodiment of the invention, a color indicator is used for indicating candidate related data, authentication related data, authenticator related data or attribute related data.

In an embodiment of the invention, a color indicator is used to provide the status of authentication.

In an embodiment of the invention, the authentication indicator shall provide the status as authenticated or not authenticated.

In an embodiment of the invention, the authentication indicator shall provide or be associated with additional information such as but not limited to date, time, remarks, score, weightage, known through, known as, work experience, quality, quantity, recommendation, endorsement, certification, nature of interaction, level of interaction or a combination thereof.

In an embodiment of the invention, the system may comprise of one or more database to store information in an electronic device.

In an embodiment of the invention, the one or more database to store information in an electronic device may be searchable by web crawlers.

In an embodiment of the invention, the one or more database to store information in an electronic device may be non-searchable by web crawlers.

In an embodiment of the invention, a user may be required to register or sign-up or join with the system for accessing the system.

In an embodiment of the invention, user registration or sign-up or joining or logging in or signing in with the system for accessing the system may be coupled with an additional aspect such as but not limited to secure code verification, SMS based verification, using of selected social accounts, digital signature, biometric authentication, email verification, cookie verification or a combination thereof.

In an embodiment of the invention, the systems and methods of the present invention further involve or comprise a search interface for searching data selected from a set of candidate related data, authenticator related data, attribute related data or any combination thereof.

In an embodiment of the invention, a user may be required to login or sign-in with the system for accessing the system after registering with the system.

In an embodiment of the invention, the systems and methods can be practiced using any electronic device. An electronic device for the purpose of this invention is selected from any device capable of processing or representing data to a user and providing access to a network or any system similar to the internet, wherein the electronic device may be selected from but not limited to, personal computers, mobile phones, laptops, palmtops, portable media players and personal digital assistants.

In an embodiment of the invention, the systems of the present invention are made accessible through a portal or an interface which is a part of, or may be connected to, the internet or World Wide Web or any similar portal, wherein the portals or interfaces are accessed by one or more of users through a computing device, whereby the user may send and receive data to the portal or interface which gets stored in at least one memory device or at least one data storage device or at least one server, and utilizes at least one processing unit. The portal or interface in combination with one or more of memory device, data storage device, processing unit and serves, form an embedded computing setup, and may be used by, or used in, one or more of a computer program product.

In an embodiment of the invention, the embedded computing setup and optionally one or more of a computer program product, in relation with, and in combination with the said portal or interface forms one of the systems of the invention.

In an embodiment of the invention, a computer program product residing on a machine readable medium may provide or enable access to system and methods of present invention, wherein the computer program product is tangibly stored on machine readable media.

In an embodiment of the invention, it may be required that the electronic device be registered or indexed. As an addition or alteration to this embodiment, it may be required that the electronic device may meet certain predetermined parameters such as but not limited to having licensed version of software or operating system of the device, or an original device itself.

In an embodiment of the invention the systems and methods of the present invention can also be used and made applicable for any online or network based activities such as but not limited to monetary transactions, online shopping, social networks, emails, chatting, on-line gaming sessions, messaging, multimedia-conferencing, application-sharing, e-voting, group-ware & collaboration, blogging, or any combination thereof

The term data may include any data or information or program or software or code which can be stored or accessible or convertible in an electronic format.

In an embodiment of the invention, multiple devices can be registered or indexed in accordance with the present invention, and one or more of these devices can be used either individually or in combination thereof for using the systems and methods of the present invention.

For the purpose of this invention, the term “candidate” is any person, organization, or representative of the organization, machine or software that uses or accesses one or more of the systems or methods of the present invention to enter an attribute linked to a candidate profile. A candidate may include an automated computer program and a robot.

For the purpose of this invention, the term “authenticator” is any person, organization, or representative of the organization, machine or software that uses or accesses one or more of the systems or methods of the present invention to authenticate an attribute linked to a candidate profile entered by a candidate. An authenticator includes an automated computer program and a robot.

For the purpose of this invention, the term “authentication indicator” indicates whether displayed profile or an attribute linked to said profile entered by a candidate is authenticated by an authenticator, by modifying, suggesting a modification, accepting or rejecting said attribute.

For the purpose of this invention, the term “user” is any person, organization, or representative of the organization, machine or software that uses or accesses one or more of the systems or methods of the present invention and deems to comprise a candidate or an authenticator or a viewer.

For the purpose of this invention, the term “communication medium” may include any means of communication presently known or might be discovered/invented in future such as but not limited to oral communication, written communication, telegrams, posts, internet, telephones, wireless communications, SMS, MMS, email, social media sites, mobile phone applications, or any combinations thereof.

For the purpose of this invention the term “authentication” deems to include and can be alternated with verification, certification, corroboration and substantiation.

The term job for the purpose of this invention means the specific opportunity provided to a person in which the person enters in a state of employment of any nature with an employer.

The term role for the purpose of this invention means a designation in which a person works for an employer.

The term jobseeker for the purpose of this invention means a person willing to take a job either in present or in future.

The term employer for the purpose of this invention means a person or a legal entity being represented by a person willing to employ a jobseeker in present or in future.

The term interface for the purpose of this invention means hardware and/or software enabling an operation on a computer system or a computer network.

The term candidate profile for the purpose of this invention means data or a set of data providing information of a candidate.

The term ‘predefined’ with respect to an attribute or a parameter means that a particular attribute or a parameter is defined at an instant prior to the instant of accessing or introducing or enabling an attribute or a parameter by the system or a user of the system.

In an embodiment of the invention, the code may have a combination of numeric or alphanumeric or symbolic characters used for protected and restricted access provided to a user to one or more digital systems or function or data, provided after necessary authentication or identification of a candidate, or an authenticator, or a viewer.

In an embodiment of the invention, the systems and methods can be practised using any electronic device. An electronic device for the purpose of this invention is selected from any device capable of processing or representing data to a user and providing access to a network or any system similar to the Internet, wherein the electronic device may be selected from but not limited to, personal computers, mobile phones, laptops, palmtops, portable media players and personal digital assistants.

In an embodiment of the invention, the systems and methods of the present invention may be enabled through a computer program product which may be embodied in a computer.

In an embodiment of the invention, systems and methods provide a computer program product embodied in a computer readable medium that enables a system for candidate authentication.

In an embodiment of the invention, one or more user can be blocked or denied access or be required to reattempt access, to one or more of the aspects of the invention.

In an embodiment of the invention, a user may have a system to record or send alert or be informed in case any other user is accessing the user's electronic device remotely.

In an embodiment of the invention, the systems and methods of the invention may simultaneously involve more than one user or more than one data storage device or more than one host server or any combination thereof.

In an embodiment of the invention, the systems and methods of the present invention are used to prevent or restrict hacking or related phenomenon such as but not limited to phishing, man in the middle attack, inside jobs, rogue access points, back door access, use of viruses and worms, use of trojan horses, denial of service attack, sniffing, spoofing, ransomware or any combination thereof.

In an embodiment of the invention, a user may enter or communicate data or request through any suitable input device or input mechanism such as but not limited to a keyboard, a mouse, a joystick, a touchpad, a virtual keyboard, a virtual data entry user interface, a virtual dial pad, a software or a program, a scanner, a remote device, a microphone, a webcam, a camera, a fingerprint scanner, a cave, pointing stick.

In an embodiment of the invention, the systems and methods of the present invention provides or enables a user interface which may allow commands for a command line interface or a graphical user interface (GUI) enabling a user to create, modify and delete data or metadata or program or logic or algorithm or parameters associated with encryption method or encryption program or encryption language.

In an embodiment of the invention, the systems and methods can be practised using any electronic device which may be connected to one or more of other electronic device with wires or wirelessly which may use technologies such as but not limited to, Bluetooth, WiFi, Wimax. This will also extend to use of the aforesaid technologies to provide an authentication key or access key or electronic device based unique key or any combination thereof.

In an embodiment of the invention, the systems and methods can be practised using any electronic device which may contain or may be infected by one or more of an undesirable software such as but not limited to a virus, or a Trojan, or a worm, malware, spyware, adware, scareware, crimeware, rootkit or any combination thereof.

In an embodiment of the invention the system may involve software updates or software extensions or additional software applications.

In an embodiment of the invention, any form of internet security such as but not limited to, a firewall or antivirus or antimalware or registry protection can be used by a user in the same or different electronic device either simultaneously or separately, along with the systems or methods of the present invention.

In an embodiment of the invention one or more user can be blocked or denied access to one or more of the aspects of the invention.

The described embodiments may be implemented as a system, method, apparatus or article of manufacture using standard programming or engineering techniques related to software, firmware, hardware, or any combination thereof. The described operations may be implemented as code maintained in a “computer readable medium”, where a processor may read and execute the code from the computer readable medium. A computer readable medium may comprise media such as magnetic storage medium (e.g., hard disk drives, floppy disks, tape, etc.), optical storage (CD-ROMs, DVDs, optical disks, etc.), volatile and non-volatile memory devices (e.g., EEPROMs, ROMs, PROMs, RAMs, DRAMs, SRAMs, Flash Memory, firmware, programmable logic, etc.), etc. The code implementing the described operations may further be implemented in hardware logic (e.g., an integrated circuit chip, Programmable Gate Array (PGA), Application Specific Integrated Circuit (ASIC), etc.). Still further, the code implementing the described operations may be implemented in “transmission signals”, where transmission signals may propagate through space or through a transmission media, such as an optical fibre, copper wire, etc. The transmission signals in which the code or logic is encoded may further comprise a wireless signal, satellite transmission, radio waves, infrared signals, Bluetooth, etc. The transmission signals in which the code or logic is encoded is capable of being transmitted by a transmitting station and received by a receiving station, where the code or logic encoded in the transmission signal may be decoded and stored in hardware or a computer readable medium at the receiving and transmitting stations or devices. An “article of manufacture” comprises computer readable medium, hardware logic, or transmission signals in which code may be implemented. A device in which the code implementing the described embodiments of operations is encoded may comprise a computer readable medium or hardware logic. Of course, those skilled in the art will recognize that many modifications may be made to this configuration without departing from the scope of the present invention, and that the article of manufacture may comprise suitable information bearing medium known in the art.

In an embodiment of the invention computer program code for carrying out operations or functions or logic or algorithms for aspects of the present invention may be written in any combination of one or more programming languages which are either already in use or may be developed in future, such as but not limited to Java, Smalltalk, C++, C, Foxpro, Basic, HTML, PHP, SQL, Javascript, COBOL, Extensible Markup Language (XML), Pascal, Python, Ruby, Visual Basic .NET, Visual C++, Visual C# .Net, Python, Delphi, VBA, Visual C++ .Net, Visual FoxPro, YAFL, XOTcl, XML, Wirth, Water, Visual DialogScript, VHDL, Verilog, UML, Turing, TRAC, TOM, Tempo, Tcl-Tk, T3X, Squeak, Specification, Snobol, Smalltalk, S-Lang, Sisal, Simula, SGML, SETL, Self, Scripting, Scheme, Sather, SAS, Ruby, RPG, Rigal, Rexx, Regular Expressions, Reflective, REBOL, Prototype-based, Proteus, Prolog, Prograph, Procedural, PowerBuilder, Postscript, POP-11, PL-SQL, Pliant, PL, Pike, Perl, Parallel, Oz, Open Source, Occam, Obliq, Object-Oriented, Objective-C, Objective Caml, Obfuscated, Oberon, Mumps, Multiparadigm, Modula-3, Modula-2, ML, Miva, Miranda, Mercury, MATLAB, Markup, m4, Lua, Logo, Logic-based, Lisp (351), Limbo, Leda, Language-OS Hybrids, Lagoona, LabVIEW, Interpreted, Interface, Intercal, Imperative, IDL, Id, ICI, HyperCard, HTMLScript, Haskell, Hardware Description, Goedel, Garbage Collected, Functional, Frontier, Fortran, Forth, Euphoria, Erlang, ElastiC, Eiffel, E, Dylan, DOS Batch, Directories, Declarative, Dataflow, Database, D, Curl, C-Sharp, Constraint, Concurrent, Component Pascal, Compiled, Comparison and Review, Cocoa, CobolScript, CLU, Clipper, Clean, Clarion, CHILL, Cecil, Caml, Blue, Bistro, Bigwig, BETA, Befunge, BASIC, Awk, Assembly, ASP, AppleScript, APL, Algol 88, Algol 60, Aleph, ADL, ABEL, ABC, or similar programming languages.

In an embodiment, the data storage unit or data storage device is selected from a set of but not limited to USB flash drive (pen drive), memory card, optical data storage discs, hard disk drive, magnetic disk, magnetic tape data storage device, data server and molecular memory.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” or “comprising,” when used in this specification, specify the presence of stated features, integers, steps, operations, elements, or components, but do not preclude or rule out the presence or addition of one or more other features, integers, steps, operations, elements, components, or groups thereof.

The process steps, method steps, algorithms or the like may be described in a sequential order, such processes, methods and algorithms may be configured to work in alternate orders. In other words, any sequence or order of steps that may be described does not necessarily indicate a requirement that the steps be performed in that order. The steps of processes described herein may be performed in any order practical. Further, some steps may be performed simultaneously, in parallel, or concurrently.

In an embodiment of the invention the term network means a system allowing interaction between two or more electronic devices, and includes any form of inter/intra enterprise environment such as the world wide web, Local Area Network (LAN), Wide Area Network (WAN), Storage Area Network (SAN) or any form of Intranet.

We claim:

1. A system for candidate authentication, wherein the system comprises,
a. at least one input interface;
b. at least one storage interface;
c. at least one request generation interface;
d. at least one request communicating interface;
e. at least one authenticating interface;
f. at least one response processing interface; and
g. at least one display interface;
wherein said at least one input interface is capable of allowing a candidate to enter at least one attribute linked to a candidate profile; and
wherein said at least one storage interface is capable of storing said at least one attribute entered by said candidate; and
wherein said at least one request generation interface is capable of generating a request for authentication of said at least one attribute stored in said at least one storage interface, to be communicated to an authenticator; and
wherein said at least one request communicating interface is capable of communicating said request for authentication from said at least one request generation interface to said at least one authentication interface; and
wherein said at least one authentication interface is capable of allowing said authenticator to submit a response to said request for authentication; and
wherein said at least one response processing interface is capable of setting an authentication indicator corresponding to said response; and
wherein said at least one display interface is capable of displaying said at least one attribute along with said authentication indicator capable of being viewed by a viewer;
and wherein said interface is also capable of storing and indexing a candidate and an authenticator.

2. The system for candidate authentication of claim 1, wherein said authenticator creates a candidate profile and invites the candidate to join the system via said communication interface, wherein on acceptance of the invitation by said candidate, the authenticator enters at least one attribute linked to said candidate profile through said input interface.

3. The system for candidate authentication of claim 1, wherein said candidate creates a candidate profile and invites said authenticator to join the system via said communication interface.

4. The system for candidate authentication of claim 1, further comprising a notification interface.

5. The system for candidate authentication of claim 1, further comprising a search interface for searching data selected from a set of candidate related data, authenticator related data, attribute related data and a combination thereof.

6. The system for candidate authentication of claim 1, further comprising a report generation interface capable of generating a report.

7. The system for candidate authentication of claim 1, wherein said authentication interface provides a hyperlink sent to said authenticator through said communication medium.

8. The system for candidate authentication of claim 1, wherein an attribute linked to said candidate profile is selected from a group of date of joining, tenure, role during employment, job functions performed during the tenure, awards/recognition of any kind during the period, salary that was awarded to the employee during that period, additional data that is of high relevance during the period of employment, feedbacks/appraisal cycles, outcomes, offer letter, termination letter, educational details, date Of joining, date of passing, class obtained, extracurricular achievements, name of the institution, name of the previous employer, criminal record, character verification, health record, credit rating, family background, financial details, address, languages know, computer knowledge, date of birth, nationality, marital status, physical attributes, and combinations thereof.

9. A system for candidate authentication, wherein the system comprises,
a) at least an electronic device;
b) at least a data storage device; and
c) at least a data processing unit;
wherein said at least an electronic device comprises,
i. at least one input interface; and
ii. at least one display interface;
and wherein said at least a data storage device comprises,
i. at least one storage interface;
and wherein said at least a data processing unit comprises,
i. at least one request generation interface;
ii. at least one request communicating interface;
iii. at least one authenticating interface; and
iv. at least one response processing interface;
wherein said at least one input interface is capable of allowing a candidate to enter at least one attribute linked to a candidate profile; and
wherein said at least one storage interface is capable of storing said at least one attribute entered by said candidate; and
wherein said at least one request generation interface is capable of generating a request for authentication of said at least one attribute stored in said at least one storage interface, to be communicated to an authenticator; and
wherein said at least one request communicating interface is capable of communicating said request for authentication from said at least one request generation interface to said at least one authentication interface; and
wherein said at least one authentication interface is capable allowing said authenticator to submit a response to said request for authentication; and
wherein said at least one response processing interface is capable of setting an authentication indicator corresponding to said response; and
wherein said at least one display interface is capable of displaying said at least one attribute along with said authentication indicator capable of being viewed by a viewer.

10. The system for candidate authentication of claim 9, wherein said authenticator creates a candidate profile and invites the candidate to join the system via said communication interface, wherein on acceptance of the invitation by said candidate, the authenticator enters at least one attribute linked to said candidate profile through said input interface.

11. The system for candidate authentication of claim 9, wherein said candidate creates a candidate profile and invites said authenticator to join the system via said communication interface.

12. The system for candidate authentication of claim 9, further comprising a notification interface.

13. The system for candidate authentication of claim 9, further comprising a search interface for searching data selected from a set of candidate related data, authenticator related data, attribute related data and a combination thereof.

14. The system for candidate authentication of claim 9, further comprising a report generation interface capable of generating a report.

15. A method for candidate authentication, wherein the method comprises steps of:
a) entering at least one attribute linked to a candidate profile through at least one input interface by a candidate;
b) storing said at least one attribute in at least one storage interface;
c) generating a request for authentication of said at least one attribute by at least one request generation interface;
d) communicating said request for authentication from said at least one request generation interface to at least one authenticating interface by at least one request communicating interface;
e) submitting a response to said request for authentication by an authenticator by said at least one authenticating interface;
f) setting an authentication indicator corresponding to said response by at least one response processing interface; and
g) displaying said at least one attribute linked to the candidate profile along with said authentication indicator by at least one display interface capable of being viewed by a viewer.

16. The method for candidate authentication of claim 15, wherein said authenticator creates a candidate profile and invites the candidate to join the system via said communication interface, wherein on acceptance of the invitation by said candidate, the authenticator enters at least one attribute linked to said candidate profile through said input interface.

17. The method for candidate authentication of claim 15, wherein said candidate creates a candidate profile and invites said authenticator to join the system via said communication interface.

18. The method for candidate authentication of claim 15, further comprising the step of sending a notification to a user by a notification interface.

19. The method for candidate authentication of claim 15, wherein an attribute linked to said candidate profile is selected from a group of date of joining, tenure, role during employment, job functions performed during the tenure, awards/recognition of any kind during the period, salary that was awarded to the employee during that period, additional data that is of high relevance during the period of employment, feedbacks/appraisal cycles, outcomes, offer letter, termination letter, educational details, date of joining, date of passing, class obtained, extracurricular achievements, name of the institution, name of the previous employer, criminal record, character verification, health record, credit rating, family background, financial details, address, languages know, computer knowledge, date of birth, nationality, marital status, physical attributes, and combinations thereof.

20. The method for candidate authentication of claim 15, further comprising the step of generating by a report generation interface.

21. The method for candidate authentication of claim 15, further comprising the step of searching data using a search interface for searching data selected from a set of candidate related data, authenticator related data, attribute related data and a combination thereof.

22. A computer program product for candidate authentication, the computer program product embodied in a computer readable medium that, when executing on a computer, performs steps comprising
a) entering at least one attribute linked to a candidate profile through at least one input interface by a candidate;
b) storing said at least one attribute in at least one storage interface;
c) generating a request for authentication of said at least one attribute by at least one request generation interface;
d) communicating said request for authentication from said at least one request generation interface to at least one authenticating interface by at least one request communicating interface;
e) submitting a response to said request for authentication by an authenticator by said at least one authenticating interface;
f) setting an authentication indicator corresponding to said response by at least one response processing interface; and
g) displaying said at least one attribute linked to the candidate profile along with said authentication indicator by at least one display interface capable of being viewed by a viewer.
